(19) United States
(12) Patent Application Publication
(10) Pub. No.: US 2012/0192229 A1
(43) Pub. Date: Jul. 26, 2012

(54) Process, instructions and architecture of a graphical user interface saved on a physical, computer read-able media device and run for the display of multiple streaming live video feeds simultaneously

(76) Inventor: Christopher Glynn R. Hunter, Woodstock, GA (US)

(21) Appl. No.: 12/930,946

(22) Filed: Jan. 20, 2011

(51) Int. Cl. H04N 5/445

(52) U.S. Cl. 725/38

(57) ABSTRACT

An apparatus including the process, instructions and Architecture of a Graphical User Interface Saved on a Physical, Computer Read-Able Media Device and Run for The Display of Multiple Streaming Live Video Feeds Simultaneously as set forth in the following specifications. The multiple live feeds play live simultaneously and continuously, unlike others represented by the most recently updated or other still image. The apparatus projects, mirrors or otherwise transmits the signals via the internet, wi-fi (wireless internet), Wi-Max, cable, satellite, cellular, VoIP, radio frequency or other connection to users on mobile media devices such as mobile phones, smart-phones, tablet computer devices, computers, and other similar mobile devices.

### FIELD OF INVENTION

The field of our invention is media distribution using computer programming arranged in Adobe Dreamweaver or similar tool and broadcast by internet connections via computer monitors, Droid, I-Phone, Blackberry, smart-phone, or other similar hand-held electronic device used to display media such as a computer, laptop, tablet or device with a display or touch-screen or keyboard or other similar program management tool.

The general purposes of our invention are:
The broadcasting or displaying of multiple, live video feeds simultaneously on one page providing the user the means for viewing multiple media events live simultaneously (As seen in FIGS. 5, 6 and 7 as major news/financial programs) on a horizontal or vertical plane displayed by computer, internet connected tablet or mobile device as listed heretofore.
To increase the speed and efficiency by which media events can be absorbed by viewers.
To offer users a higher paced experience viewing experience of media events (such as news or sports).
To distribute information fast to the general public.
To consolidate the reporting of consenting television channels.

### DESCRIPTION

We have invented a graphical user interface to display multiple streaming (or slightly delayed) video feed broadcast live simultaneously on LCD screens, computer monitors, Droid, I-Phones, Blackberries, smart-phones, computer, laptop, tablet, device and mobile devices with a display screen, touch-screen, keyboard and or buttons or other similar hand-held electronic devices used to display media via the internet, wi-ft (wireless internet), Wi-Max, cable, satellite, cellular, VoIP, radio frequency or other connection to the internet including 2G, 3G, 4G or other high speed or broadband networks, antennae or web connection.

A preferred embodiment of the graphical user interface as seen in FIG. 1 is saved on a physical, computer Read-Able Media and displayed. In the constructive reduction to practice, an Adobe Dreamweaver program is used to generate the graphical user interface and it is delivered using a hosting service if necessary to distribute to various areas of the world. We arranged and saved tables to contain the media players and keep them in line horizontally. Shown as #5 on FIG. 5 is a streaming stock ticker which we included in our reduction to practice. In our preferred embodiment, the interface can be transmitted using regular internet, WI-FI or heretofore mentioned mobile phone signals. When used by the heretofore mentioned computer and mobile devices, the results will be the same or similar to those visible in FIGS. 2, 3, 4, 5 and 6.

The feeds are then set to auto play upon user entry with all but one volume set to 0. The volume controls and pause, record fast-forward, rewind and other similar buttons are visible to the user when they hover over the videos. The interface may also be altered in cosmetic appearance if needed. The ability to pause, rewind and record the video feeds one or more at a time is planned using the common methods in the area of public use.

Chosen recordings of viewed media events are to be shared with others via email, text, Bluetooth, YouTube or other similar data sharing methods.

The users' screens can be scrolled up or down on a vertically held device or window or left and right on a horizontally held device or window as is needed using the device's usual method of screen controls (example: computer mouse, touch screen or side bar navigator). We intend that the volume can be enabled for any video that the mouse or selector is moved over but also with customizable settings to be controlled manually by the user.

The videos will run indefinitely as long as the user's device is on and will disengage when the device is shut off, the application or window is closed or the device is put to “sleep” by timing out, being closed or being holstered as is common with most current computers and hand-held devices. This is accomplished by the devices' methods so needs not be included in our invention.

Advertising or other cash flow generating links or commercials may be positioned around the videos, take place totally or partially in front of the videos or at regular intervals. They can be located anywhere that is useful. All methods of advertising may be used.

### Prior Art

During our prior art search many video files and live feeds were discovered. Commonly, video footage is collected and contained in small, down-loadable files that can be selected and viewed. We also discovered examples displaying pictures that represent its respective video. Prior art makes video available in down-loadable files represented by links or by the pictures noted. Once selected, the link or picture begins the video it represents.

Note U.S. Pat. No. 4,729,027 awarded to Hakamada and Wakabayashi and assigned to Sony for picture in picture awarded rights to putting a picture into a picture (as commonly seen with television sets) which is currently expired.

Our claim and invention differ in that we do not put a picture inside a picture. We have aligned live video feeds or channels to be displayed on a horizontal or vertical viewing screen via wi-fi (wireless internet) connection. Wireless Max connection, cable, satellite, cellular, VoIP, radio frequency or other connection to the internet including 2G, 3G, 4G or other high speed networks or antennae to display several independent live video sources playing simultaneously.

Found in the area of public use was the use of web-cam displays and security or area monitoring cameras shown together for security or area monitoring systems which is of an entirely different nature but is mentioned here for the sake of thoroughness. These are for an entirely different use and method than what we are making claim to.

Found in the area of public use was the use of a single media player or app to view a single live view on mobile devices of one specific television channel's broadcast which is becoming more popular. As with other prior art found, our invention creates a sudden and drastic change to the user's experience and creating additional commercial value. This value is created by allowing the user to view multiple channels simultaneously and more immediate viewing. Ad space can be created in surrounding areas to generate income.

Unlike U.S. Pat. No. 7,188,122, issued to Smith; Greg (Bellevue, Wash.), Krumm; John (Redmond, Wash.), each of our live video feeds play at full speed simultaneously in every media player and play continuously at all times during use. U.S. Pat. No. 7,188,122 makes videos available on a computer and maintains a camera directory file containing the names of available feeds, and the name and location of an image file for each feed. The image file includes image data corresponding to a current frame of the feed and an index indicative of a frame sequence number. Each time a new frame becomes available, image data representing the frame is put into its associated image file, in place of previously stored image data. A client application chooses a feed from the camera directory file, then accesses the associated image file and makes a copy of the image data. When the client wants a new frame, it determines if the image file index has changed. If so, the client copies the new image data.

U.S. Pat. No. 7,188,122 is displaying only the one most recent frame of the video data as a still shot that represents the video as a still image and is thus limited and not playing live. It resets/updates the single frame representation as the user enters the display but remains a still image unless selected. This is a commonly used arrangement on sites that display or transmit live video feeds but it is different than what we are claiming and is totally different from the application we are making claims to.

### Advantages over Prior Art

It creates a different, sudden and drastic change to the viewing experience by allowing the user to view multiple streaming live video feeds at one time being broadcast from a website or group of websites horizontally or vertically.
It allows the user to experience interchangeable live streaming video feeds simultaneously, either horizontally or vertically, on the mobile devices listed heretofore.
It allows users to monitor or absorb information at a faster rate than single media streams or individual videos.
It distributes information on one display to the public more rapidly than traditional methods of media reporting.
It eliminates the need to manually change between videos, links or channels by displaying multiple media events at once.
It simplifies the process of getting one's news.
It offers a faster pace for those who prefer it over single video media event reporting or print.
Servers can be used if needed.
High speed hosting services may also be used if needed to support bandwidth requirements to areas.

If they choose, feeds can be blown up to full screen using individual media player controls or other controls placed by us on each live video feed.

Our invention allows any user to monitor multiple channels live at once anywhere with a mobile device, tablet or computer. No artisan or company, knowledgeable in the field of web-based media, has to date built or applied for a patent for personal or financial gain. The unusual and surprising result of our invention is the ability of users to obtain new information at a faster rate by live video resources than other forms currently used and do it from any location using stationary computers or any mobile phone, smart-phone, hand-held, I-Pad, Droid or any other mobile communications device with a screen and data connection of any kind. Original High Definition footage can be used or enhanced by High Definition media players and modifications to achieve a similar result.

### BRIEF DESCRIPTION OF THE DRAWINGS

The file of this patent contains at least one drawing executed in color. Copies of this patent with color drawing(s) will be provided by the Patent and Trademark Office upon request and payment of the necessary fee.

FIG. 1 is a copy of the program code used to demonstrate our example constructive reduction to practice. Each of the videos displayed are actually playing immediately and continuously upon use and are live or as slightly delayed as possible.

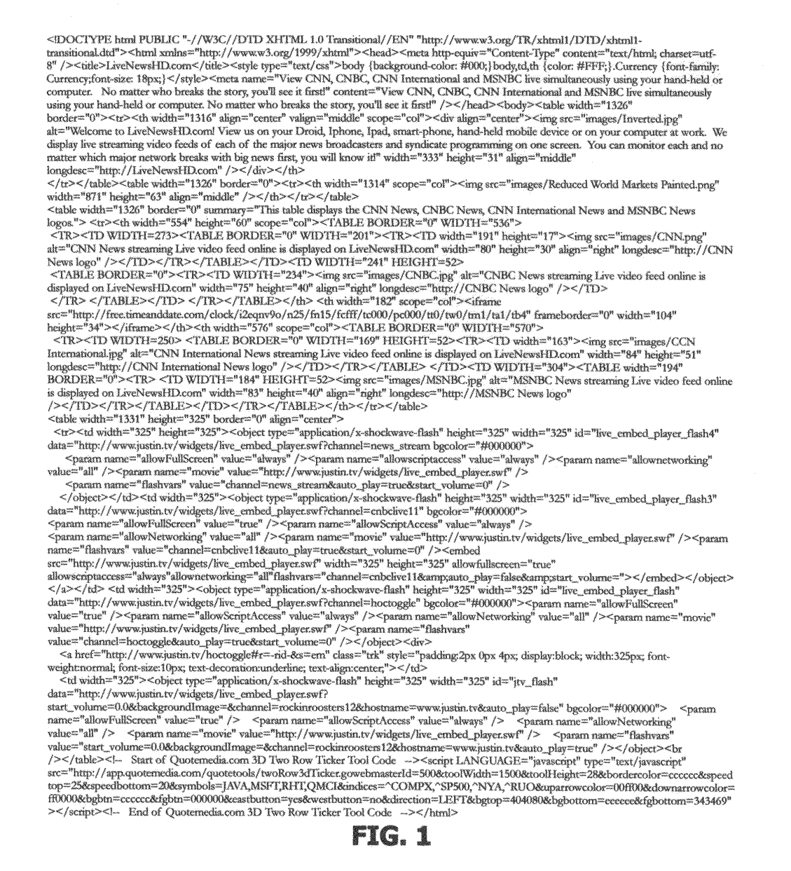

FIG. 2 is a 3D drawing of our graphical user interface reduced to practice horizontally on a tablet computer device. Each of the videos displayed are actually playing and are live and the page scrolls left and right when paged through using the device's internal commands.

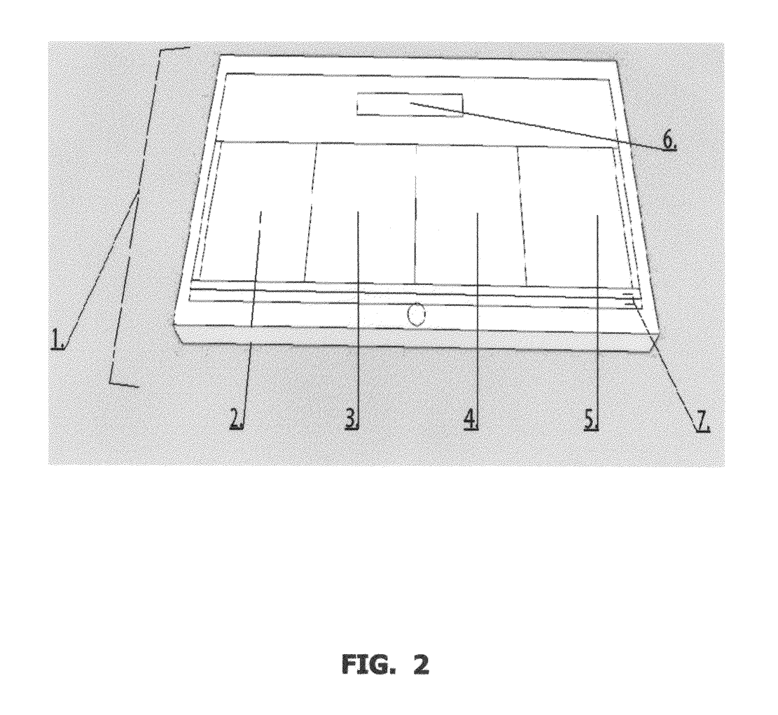

FIG. 3 is a drawing of our graphical user interface displayed vertically with each live continuous video feed is represented by numbers 1, 2, 3 & 4, reduced to practice horizontally on a tablet computer device. Each of the videos displayed are actually playing and are live.

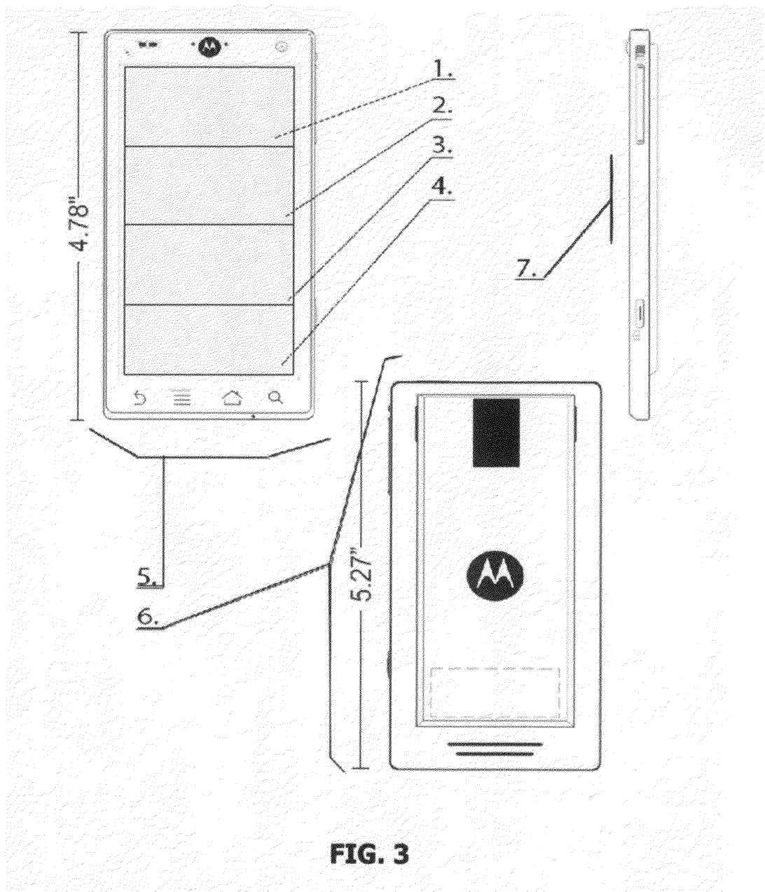

FIG. 4 is a drawing of our graphical user interface with color displayed vertically on a hand-held mobile phone device. This version will scroll up and down vertically. Although each of the videos in the FIGS appears as a still shot, they are actually video feeds continuously playing live from the time the graphical interface is enabled by the user. The screen can be paged up or down as is common in the area of public use of mobile devices.

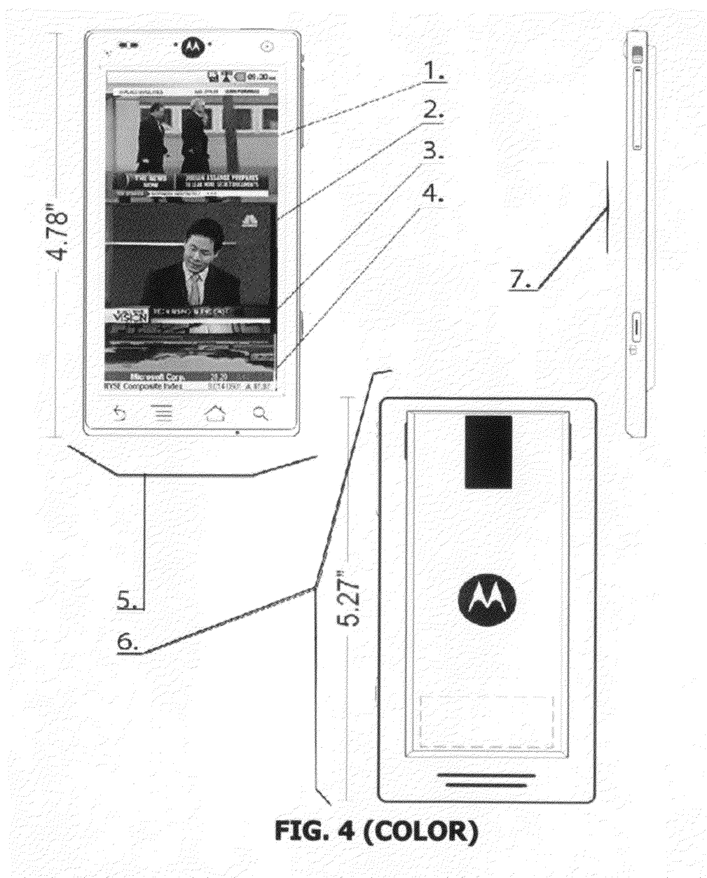

FIG. 5 is a reduction to practice view with color as it is seen on a full screen monitor or television set. Each video seen is playing live simultaneously. Although it is not possible to see with drawings, it is understandable when accompanied by the FIG. tables.

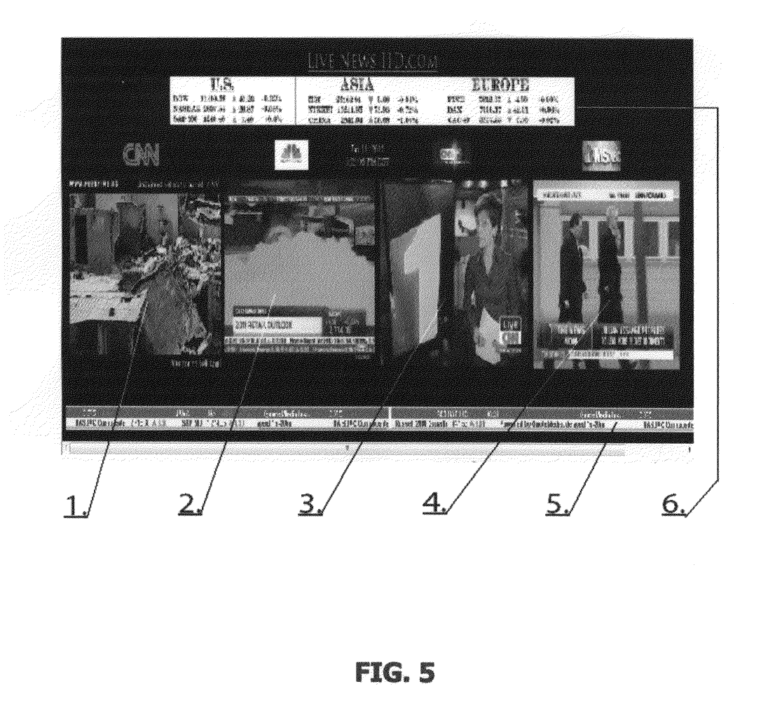

FIG. 6 is an example of our invention being displayed on a horizontally held mobile device. The scroll function of the device is used to pan left or right in order to view areas not in sight as on FIG. 2.

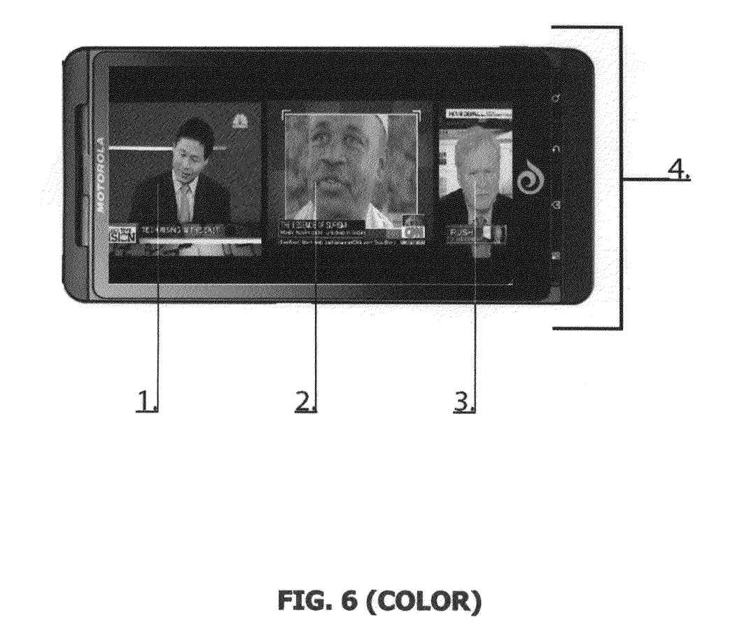

### ALTERNATIVE EMBODIMENTS OF OUR GRAPHICAL USER INTERFACE

The graphical user interface can also be saved on a magnetic or optical disk or other computer readable memory device.
Single media players or multiple players can be assembled or arranged using absolute positions, anchors, <div> codes. Single embed codes can be combined on one page of code.
The players or embed codes can also be separated by i-frames, tables.
The graphical user interface can also be visible on one page with no paging through needed.
A cover-flow version of browser could be used (similar to the I-Tunes cover-flow system) in place of our preferred embodiment using the built in methods of the mobile device which allow the user to page through the categorized channels.
Tab arrows could be used to page through channels but in our preferred embodiment the user's device controls can be used to navigate as is normal in the area of public use.
In-house or outsourced hosting and internet connection hubs can be used, owned or leased to accommodate the bandwidth if needed.
Adaptive Bit Rate technology can also be used in conjunction with our invention to allow video degradation when necessary due to signal or connectivity drops.
Bit Rate Technology can be useful and likely will be used in conjunction in the future with our invention to allow automatic video degradation when necessary due to fluctuating signal or connectivity drops. It may not be necessary for functionality so is not included in our reduction to practice.
The tables can be different sizes and shapes and the media players used can be of many different types with different sets of controls.
The interface design can be rearranged if necessary to optimize the space for advertisement.
Small video commercials can play while videos load if that is necessary, “pop up” or run in the corners, bottom or other places around the graphical interface or each respective live video feed if desired.
The actual display can be modified to fit the user's screen exactly or to be scrolled or panned left or right/up and down using the user's device's moving functionality.
The graphical user interface code or program can also be saved on a magnetic or optical disk or other computer readable memory.
A user configurable video connection timeout function is provided. The user uses this function to set the desired connection timeout for video feeds. This allows the user to adjust behavior for optimal results in various types of networks.

Although the description above contains many specificities, these should not be of the presently preferred embodiments of this invention. Thus the scope of the invention should be determined by the appended claims and their legal equivalents, rather than by the examples given.

In conclusion, our graphical user interface provides a new and unique media viewing experience. a faster pace for those who prefer it, reduced effort in looking individually for the media events, news stations or other feeds of choice and aids more rapid information absorption than what currently exists.

Although other modifications and changes may be suggested by those skilled in the art, it is the intention of the inventors to embody within the patent warranted hereon all changes and modifications as reasonably and properly come within the scope of their contribution to the art.

1) An apparatus, process, and architecture of a graphical user interface saved on a physical, computer read-able media device and run for the display of multiple streaming live video feeds simultaneously and continuously.

2) An apparatus as claimed in claim 1, wherein said characteristics are side by side horizontally or one atop another vertically on a plane that can be paged through.

3) An apparatus as claimed in claim I, wherein all chosen live video feeds or television channels play simultaneously horizontally or vertically.

4) An apparatus as claimed in claim 1, wherein multiple live video feeds or television channels are broadcast and played simultaneously and transmitted via internet connection, wi-fi (wireless internet), Wi-Max, cable, satellite, cellular, VoIP, radio frequency or other connection to the internet including 2G, 3G, 4G or other high speed or broadband networks, antennae, web or other data connection to mobile media devices such as mobile phones, smart-phones, tablet computer devices, computers, and other similar mobile devices via computers, Droids, I-Phones, Blackberries, smart-phones, computer, laptop, tablet or device with a display or touch-screen or keyboard or other similar hand-held electronic devices.

5) An apparatus as claimed in claim 4, wherein said live video command applications display the data group continuously updated by the live video feed or television channel.

6) An apparatus as claimed in claim 4, wherein said multiple live video feeds broadcast are news channels.

7) An apparatus as claimed in claim 4, wherein said multiple live video feeds broadcast are sports related channels. or financial channels.

8) An apparatus as claimed in claim 4, wherein said multiple live video feeds broadcast are financial channels.

9) An apparatus as claimed in claim 4, wherein said multiple live video feeds broadcast are any type or live real time (or delayed by seconds) media event.

10) An apparatus as claimed in claim 1, wherein the simultaneous and constantly playing live video and audio channels are broadcast in high definition.

11) An apparatus as claimed in claim 1, wherein the simultaneous and constantly playing live video and audio channels are used to display multiple video and audio media events live simultaneously via the internet, wi-fi (wireless internet), Wi-Max, cable, satellite, cellular, VoIP, radio frequency or other connection to the internet including 2G, 3G, 4G or other high speed or broadband networks, antennae, web or other data connection to users on mobile media devices (mobile phones, smart-phones, tablet computer devices, computers, and other similar mobile devices.

12) An apparatus as in claim I wherein the signals are directly transferred from a satellite or cable receiver into a server after being converted into an IP or HDSDI signal and then transmitted via the internet or other heretofore mentioned connections to heretofore mentioned mobile devices or computers.

13) An apparatus as in claim I wherein the heretofore mentioned multiple live simultaneously playing signals are transmitted to television sets via existing cable, satellite, internet or other similar method.

14) An apparatus as in claim 11 wherein servers are used to execute the above programs.

15) An apparatus as in claim 1 wherein the feeds can be controlled, paused, rewound, recorded, and the volume adjusted.

16) An apparatus as described in claim 11 wherein the heretofore mentioned live video feeds can be chosen by the user and their settings or choices saved.

17) An apparatus as described in claim 11 wherein the user can select or record a certain section of the viewed media events and forward or share them with others via email, text, Bluetooth YouTube or other similar media sharing methods available.
